(19) United States
(12) Patent Application Publication
(10) Pub. No.: US 2007/0143423 A1
(43) Pub. Date: Jun. 21, 2007

(54) Method and system for allowing a session initiating user to select one or more privacy settings to be applied to an instant messaging session from among multiple possible privacy controls

(76) Inventors: Oliver Kieselbach, Hoevelhof (DE); Niklas Heidloff, Salzkotten (DE); Michael R. O'Brien, Westford, MA (US); Gregory R. Klouda, Lancaster, MA (US)

Correspondence Address: LOTUS AND RATIONAL SOFTWARE;McGuinness & Manaras LLP, 125 NAGOG PARK, ACTON, MA, 01720, US

(21) Appl. No.: 11/314,212

(22) Filed: Dec. 21, 2005

(51) Int. Cl. G06F 15/16

(52) U.S. Cl. 709/206

(57) ABSTRACT

A system and method allowing a session initiator to select from among multiple privacy levels to be applied to an instant messaging session. When a user initiates an instant messaging session, multiple selectable privacy settings are presented, from which the user can select. The disclosed system may provide a session initiator with a user interface that enables selection from among privacy settings that prevent the session contents from being copied and pasted while the session is in progress, prevent any saving of the session contents by any user, prevent the session contents from being forwarded via electronic mail, prevent display of previously viewed session contents while the session is in progress, and/or prevent screen shots from being made of the session contents while the session is in progress. Flags representing one or more of the multiple privacy settings may be stored in association with an ongoing session, and/or in association with the stored contents of a previous session. In one embodiment, only the session initiator can select from among the multiple privacy settings, and may be provided with indication in the user interface of the privacy settings that are supported by individuals listed in their buddy list.

### FIELD OF THE INVENTION

The present invention relates generally to controls for electronic messaging systems, and more specifically to a system and method for allowing a session initiator to select from among multiple privacy levels to be applied to an instant messaging session.

### BACKGROUND OF THE INVENTION

As it is generally known, instant messaging systems are software applications that enable two or more computer system users to exchange electronic messages in realtime. Instant messaging (IM) systems are examples of synchronous communication systems, since they generally require that participants in a communication session be simultaneously online. Sometimes also referred to as “chatting,” instant messaging has become increasing adopted by both business and personal users.

In order to set up an instant messaging session, an initiating user (also referred to as the “session initiator”) typically indicates the usernames (also known as “screen names”) of other users to be invited to participate in the session. For example, many existing systems enable the initiating user to select desired session participants from a contact list maintained for each user known as a “buddy list”. Existing systems further allow users to see other user's current availability or online status, which may be automatically maintained by the instant messaging system, and/or explicitly set by the users themselves. Examples of popular existing instant messaging systems include America Online®, Inc.'s Instant Messenger (AIM), Microsoft®'s MSN Messenger/Windows Messenger and Yahoo!® Messenger.

A problem with existing instant messaging systems relates to their inability to provide sufficiently varied privacy levels with regard to the contents of different instant messaging sessions. For example, some existing systems allow the contents of an instant messaging session to be saved into a file. As a result, the session contents can later be forwarded by a session participant to one or more non-participants. Since different instant messaging sessions may include comments or other content having different levels or kinds of sensitivity, it may be desirable to limit access to such contents in a variety of specific ways, depending on the specific subject matter being discussed.

One existing instant messaging system has provided an “off the record” mode that may be selectively enabled by a user to preclude remote users from recording the communications being transmitted during an instant messaging session. However, while such a system provides the user with the ability to prevent users from recording the contents of a session, it is significantly limited in its flexibility. This inflexibility may be a disadvantage for users desiring to control how the contents of an instant messaging session are used or made available with respect to a variety of specific potential operations. In particular, a user may wish to control how the contents of an instant messaging session are accessed or made available in specific ways, based on the specific sensitivity of the contents or subject matter involved. The contents of one somewhat sensitive instant messaging session may call for a different level of privacy protection than the contents of another, more sensitive session, and a third instant messaging session may include content calling for yet another, completely different type of privacy control. A user may be aware of such specific privacy needs for session contents when he or she initiates a session, or a need for a specific type or level of privacy control may arise during a session. In spite of these needs, existing instant messaging systems have not provided users with the ability to choose from among multiple content privacy controls or privacy levels to be applied to the contents of an instant messaging session, on a session by session basis. This shortcoming prevents users from being able to apply the appropriate type or level of privacy controls to the contents of specific instant messaging sessions.

For the above reasons, it would be desirable to have a new system for providing an instant messaging system that allows a user to select from among multiple types or levels of privacy controls for the contents of an upcoming or ongoing instant, messaging session.

### SUMMARY OF THE INVENTION

To address the above and other shortcomings of prior solutions, a system and method are disclosed for allowing a session initiator to select from among multiple privacy levels to be applied to an instant messaging session. In the disclosed system, when a user initiates an instant messaging session, multiple selectable privacy settings are presented, from which the user can select. In one embodiment, the disclosed system provides a session initiator with a user interface that enables selection from among the following privacy settings:

Prevent the session contents from being copied and pasted while the session is in progress.

Prevent any saving of the session contents by any user.

Allow the session contents to be saved, but prevent the session contents from being forwarded via electronic mail.

Prevent display of previously viewed session contents while the session is in progress.

Prevent screen shots from being made of the session contents while the session is in progress.

Flags representing one or more of the above settings may be stored in association with an ongoing session, and/or in association with the stored contents of a previous session, such as a chat transcript. In one embodiment, only the session initiator can select from among the multiple privacy settings. Further in one embodiment of the disclosed system, an initiating user is provided with indication in the user interface of the privacy settings that are supported by individuals listed in their buddy list.

Thus there is provided a new system for providing an instant messaging system that allows a user to select from among multiple types or levels of privacy controls for the contents of an upcoming or ongoing instant messaging session.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing operation of hardware and software components providing an illustrative embodiment of the disclosed system;

FIG. 2 is a flow chart showing steps performed in an illustrative embodiment of the disclosed system;

FIG. 3 is a simplified screen shot showing at least a portion of a user interface provided by an illustrative embodiment of the disclosed system to set up an instant messaging session with selected privacy settings;

FIG. 4 is a simplified screen shot showing at least a portion of a user interface provided by an illustrative embodiment of the disclosed system to invite a user to an instant messaging session;

FIG. 5 is a simplified screen shot showing at least a portion of a user interface provided by an illustrative embodiment of the disclosed system during an instant messaging session; and

FIG. 6 is a simplified screen shot showing at least a portion of a user interface provided by an illustrative embodiment of the disclosed system to enable a user to view and/or select one or more instant messaging privacy settings.

### DETAILED DESCRIPTION OF EXEMPLARY EMBODIMENTS

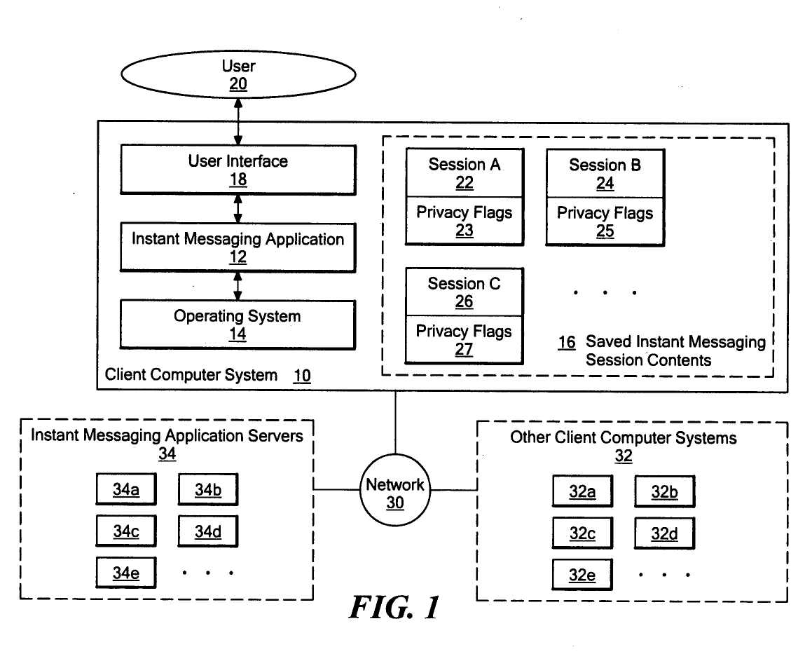

As shown in FIG. 1, an illustrative embodiment of the disclosed system operates using a number of software components executing on at least one computer system, shown for purposes of illustration as the client computer system 10, instant messaging application servers 34, and other client computer systems 32. Further for purposes of illustration, instant messaging application servers 34 are shown including of computer systems 34a, 34b, 34c, 34d, etc., and other client computer systems are shown including computer systems 32a, 32b, 32c, 32d, 32e, etc. The client computer system 10, instant messaging application servers 32, and other client computer systems 32 may each, for example, include at least one processor, program storage, such as memory, for storing program code executable on the processor, and one or more input/output devices and/or interfaces, such as data communication and/or peripheral devices and/or interfaces. The client computer system 10, instant messaging application servers 34, and other client computer systems 32 are communicably connected by a communication network 30, such as a Local Area Network (LAN), the Internet, or the like. The client computer system 10, calendar and scheduling application servers 24, real-time collaboration application servers 28, and other client computer systems 26 may each further include appropriate operating system software, as illustrated by the operating system software 14 shown in the client computer system 10.

The client computer system 10 is shown further including instant messaging application software 12 that provides a graphical user interface 18 to a user 20. The user interface 18 may be any specific kind of user interface, such as a user interface provided through a Web browser program or the like, and based on the contents of a number of Web pages rendered to the user 20. The client computer system 10 is also shown including a number of saved instant messaging session contents 16. The saved instant messaging session contents are shown for purposes of illustration including the saved contents of an instant messaging Session A 22, which are associated with a number of privacy flags 23, the saved contents of an instant messaging Session B 24, which are associated with a number of privacy flags 25, the saved contents of an instant messaging Session C 26, which are associated with a number of privacy flags 27, etc. The privacy flags associated with each of the saved instant messaging session contents of FIG. 1 control the operations that can be performed on the associated saved instant messaging contents. For example, a privacy flag may indicate that the associated saved instant messaging session contents cannot be forwarded through an electronic mail application program, and/or some other limitation on operations that can be performed. The disclosed system further allows for privacy flags to be associated with an instant messaging system that is currently underway. For example, a privacy flag for an instant messaging session that is currently underway may indicate that the contents of the session cannot be saved, that the contents of the session cannot be copied and pasted while the session is in progress, that previously viewed session contents should not be displayed while the session is in progress, that screen shots cannot be made of the session contents while the session is in progress, and/or other limitations on operations that can be performed. During operation of the illustrative embodiment shown in FIG. 1, the instant messaging application 12 determines the privacy settings for a given instant messaging session, and stores privacy flags representing those settings in association with either the saved contents of the session, and/or in association with the session while it is currently underway. For example, specific privacy settings indicated by the privacy flags may be enforced either directly by the instant messaging application 12 and/or in through interfaces provided by the operating system software 14. Moreover, while for purposes of concise illustration, the instant messaging application software 12 and operating system software 14 are shown executing in the client computer system 10, similar software programs are present in the other client computer systems 32, and operate similarly to enforce specific privacy settings on the other client computer systems 32. Those skilled in the art will also recognize that the privacy flags of FIG. 1 are just one way of representing and/or storing privacy levels provided by the disclosed system, and that other specific techniques may be used in alternative embodiments.

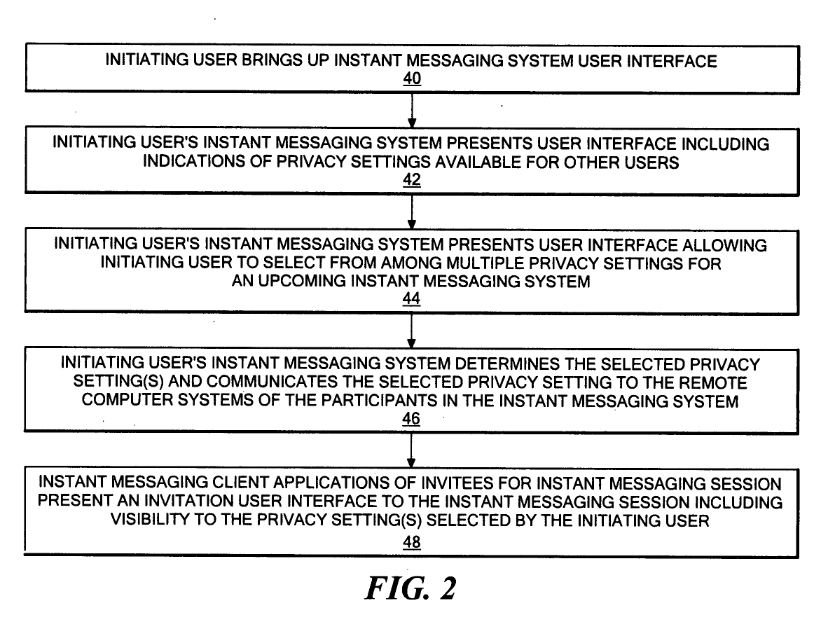

FIG. 2 is a flow chart showing steps performed in an illustrative embodiment. As shown in FIG. 2, at step 40 an initiating user brings up an instant messaging user interface in order to start an instant messaging session. At step 42, the disclosed system presents a user interface including indications of privacy settings that are available for other users. For example, at step 42, the user may be presented with a buddy list that includes indications of which privacy settings are enabled and/or supported by one or more specific users contained in the buddy list. In an embodiment in which the privacy settings for a given user are stored on an application server, such as one of the instant messaging application servers 34 of FIG. 1, those settings may be read over the network 30 by the instant messaging application 12 when providing the indications of which privacy settings are supported by specific users.

At step 44, a user interface is presented allowing the initiating user to select from among multiple privacy settings to be applied to the instant messaging session that is being initiated. After the initiating user selects or otherwise enters indications of the desired privacy setting(s), at step 46 the disclosed system determines the selected setting and communicates the selected setting to remote computer systems of users that the initiating user is inviting to participate in the session. For example, at step 46, instant messaging application 12 may cause a number of invitation messages to be sent over the network 30 of FIG. 1 to one or more of the other client computer systems 32 that are associated with corresponding ones of the users that the initiating user is inviting to the session. Such messages may, for example, include one or more SIP (Session Initiation Protocol) <INVITE> requests, where the messages have been extended to include the selected privacy settings for the session. Such extended SIP <INVITE> messages may, for example, include the selected privacy settings within additional header information or fields, or elsewhere. Those skilled in the art will recognize that the disclosed system may be implemented using other specific types of messages exchanged between the initiating user's computer system and the computer systems of users that are invited to join the session, and that SIP <INVITE> messages are described only for purposes of explanation, and with regard to only one possible embodiment of many alternatives using various specific types of messages.

At step 48, the instant messaging client application software on the computer systems of the users invited to the instant messaging session presents a user interface that enables them to view the privacy settings selected by the initiating user, and to either join the session or decline the invitation.

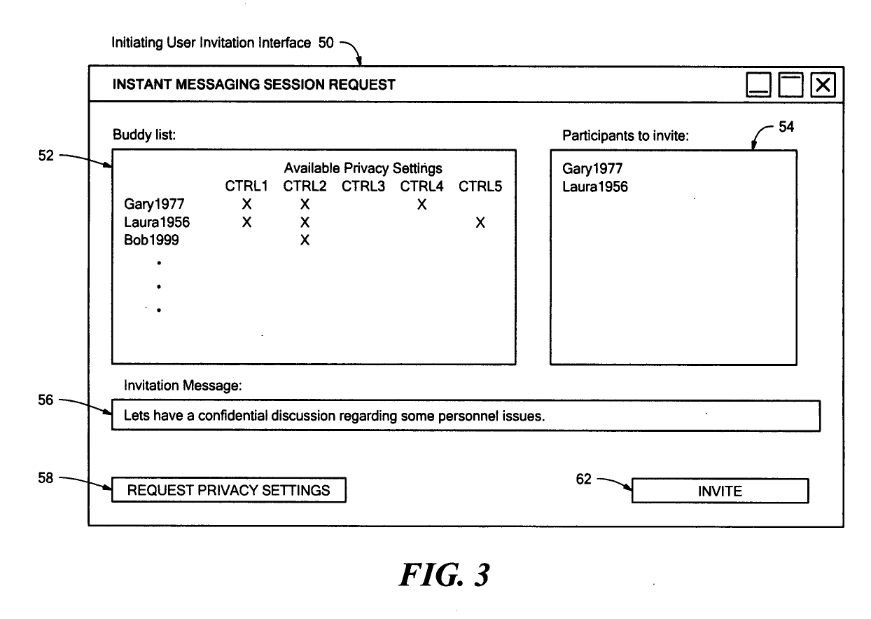

FIG. 3 is a simplified screen shot showing at least a portion of a user interface 50 provided by an illustrative embodiment of the disclosed system to an initiating user, in order to set up an instant messaging session with selected privacy settings. The user interface 50 of FIG. 3 is shown including a buddy list 52 of contacts of the local user, a list 54 to be filled with the names of other users to be invited to the session, an invitation message field 56 in which to enter a message to be included in any resulting invitation message, a button 58 which enables the initiating user to control the privacy settings to be used with the session, and a button 62 that enables the initiating user to send invitation messages to the other users to be invited to the session. For example, the button 58 may be a graphical button display object which, when clicked on with a mouse, allows the initiating user to select and/or indicate the privacy setting(s) to be associated with the requested instant messaging session.

The buddy list 52 of FIG. 3 further includes indications of the available privacy settings for each of the users that are listed. For example, as shown in FIG. 3, each user listed in the buddy list may have some number of privacy controls available for use in instant messaging sessions, shown for purposes of illustrations as privacy controls CTRL1, CTRL2, CTRL3, CTRL4, and CTRL5. An X mark under any one of the possible privacy controls indicates that an instant messaging session with the corresponding user may be subject to that privacy control. The privacy controls that are available for any given user may be determined based on the capabilities of the instant messaging application software used by that user on their local computer system, and/or on whether that user has explicitly enabled or disabled specific privacy controls through a user interface provided by such instant messaging application software.

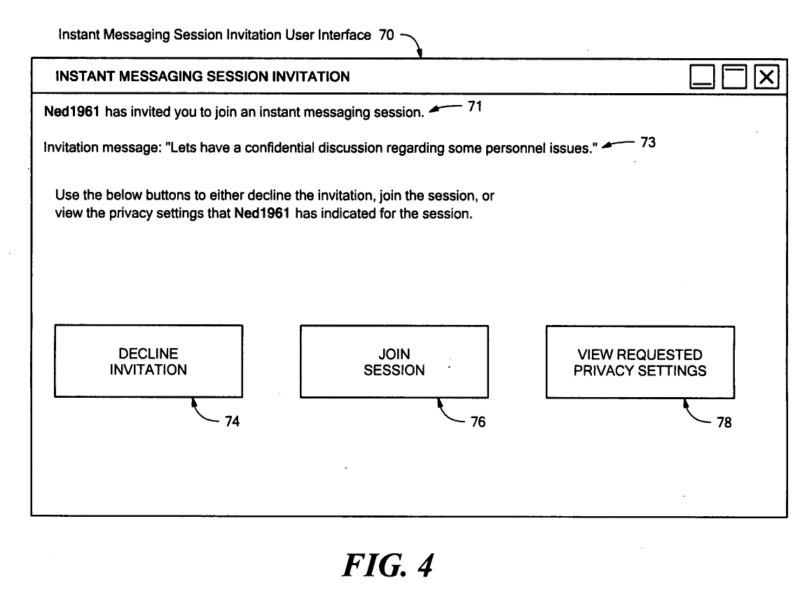

FIG. 4 is a simplified screen shot showing at least a portion of a user interface 70 provided by an illustrative embodiment of the disclosed system in response to receipt of a message inviting a user to an instant messaging session. As shown in FIG. 4, the user interface 70 includes an indication 71 of the initiating user that issued the invitation, an invitation message field 73, a graphical button display object 74 that allows the receiving user to decline the invitation, a graphical button display object 76 that allows the receiving user to accept the invitation, and a graphical button display object 78 that allows the receiving user to view the privacy settings requested by the initiating user. For example, when a receiving user clicks on the button 74, the invitation is declined, when the receiving user clicks on the button 76 the receiving user joins the session, and when the receiving user clicks on the button 78, they are presented with a display indicating the privacy settings requested by the initiating user.

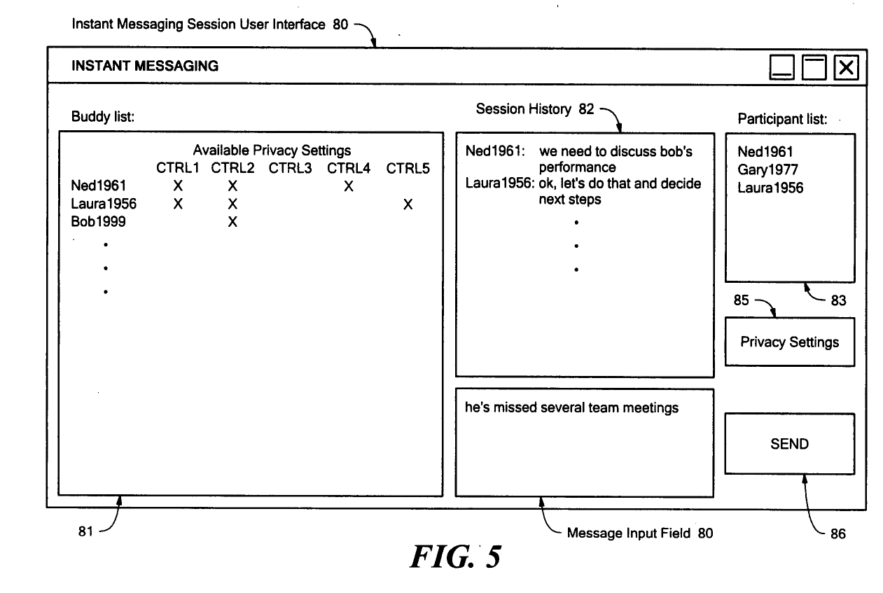

FIG. 5 is a simplified screen shot showing at least a portion of a user interface 80 provided by an illustrative embodiment of the disclosed system during an instant messaging session. As shown in FIG. 5, the user interface 80 includes a buddy list 81, a session history region 82, a message input field 84, a participant list 83, a graphical button display object 85 allowing a participating user to view the privacy settings associated with the current session, and a graphical button display object 86 which enables the user to add the contents of the message input field 84 to the session history region 82. For example, when a user participating in the instant messaging session clicks on the button 85, the disclosed system provides a non-initiating user to view the current privacy settings for the session, and allows an initiating user to view and/or modify the privacy settings for the session.

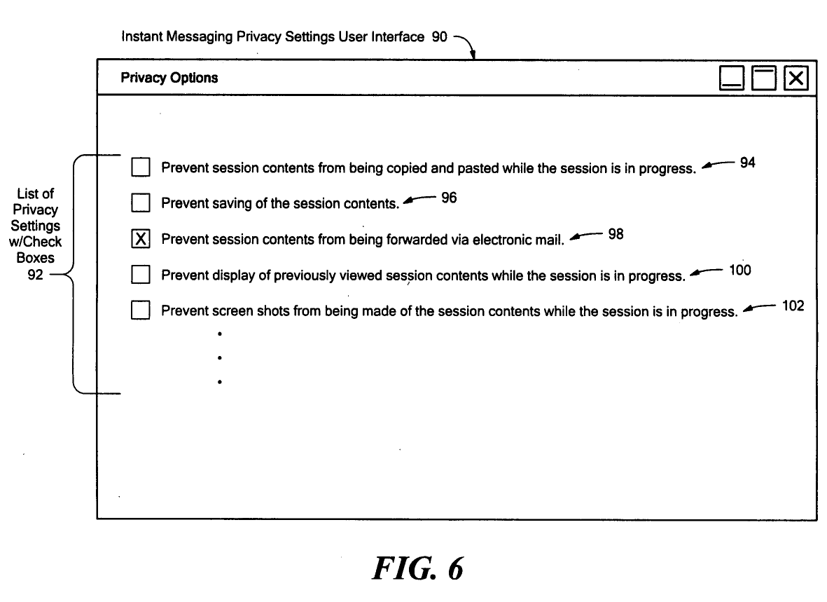

FIG. 6 is a simplified screen shot showing at least a portion of a user interface 90 provided by an illustrative embodiment of the disclosed system to enable a user to view and/or select one or more instant messaging privacy settings. The user interface 90 may, for example, be provided in response to a user clicking on the graphical button display object 58 of FIG. 3, the graphical button display object 78 of FIG. 4, or the graphical button display object 85 of FIG. 5. In one embodiment, the specific privacy settings for an instant messaging session can be set prior to the session, and/or modified during the session, only by the initiating user for that session. Accordingly, in such an embodiment, indications of which privacy settings are set in the user interface 90 may be changed only by the initiating user for the associated instant messaging session, and may only be viewed by other participating users in the session.

As shown in FIG. 6, a list of privacy settings with check boxes 92 is presented. The privacy settings that have their check boxes checked are the privacy settings that have been selected for the associated instant messaging session. In the example of FIG. 6, a privacy setting 94, if selected, prevents the contents of the instant messaging session from being copied and pasted while the session is in progress. A privacy setting 96, if selected, prevents saving of the instant messaging session contents. A privacy setting 98, if set, prevents the contents of the instant messaging session from being forwarded using an electronic mail application. A privacy setting 100 prevents display of previously viewed session contents while the session is in progress. For example, in one embodiment, if the privacy setting 100 is selected, the contents of the session history region 82 (FIG. 5) would be erased each time a new message is added to the session history region 82 when the user clicks on the Send button 86 (FIG. 5) to add the contents of the message input field 84 (FIG. 5) to the session history region 82.

A privacy setting 102, if set, prevents screen shots from being made of the session contents or history while the session is in progress. For example, in one embodiment, if the privacy setting 102 is selected, then the user would be prevented from obtaining a screen shot of the session history region 82 of FIG. 5. For purposes of the present disclosure, a the term “screen shot” (also referred to sometimes as a “screen capture”) refers to a copy of at least a portion of the display device screen's contents, that can be saved as a graphics file or copied into a document or graphics editor.

While for purposes of illustration, the privacy setting 98 is shown having been selected through a check mark in its corresponding check box, the disclosed system allows for any one or more of the privacy settings in the list of privacy settings 92 to be selected. The list of privacy settings 92 may include any specific number of selectable privacy settings, as appropriate for a given embodiment. Moreover, while check boxes are provided in the list of privacy settings 92 for purposes illustration in FIG. 6, the disclosed system may be embodied using any specific user interface mechanism to allow selection of one or more privacy settings.

In general, while the above description refers to embodiments of the disclosed system having specific user interface components, such as buttons, fields, specific layouts, formats, etc., the present invention is not so limited. Accordingly, those skilled in the art will recognize that alternative embodiments may use any other specific user interface components to provide information to and receive information from a user. Such alternative embodiments may use any user interface components that are selectable by a user with a mouse user interface device, keyboard, or other equivalent devices, such as pull down menus, check boxes, and/or other types of user interface components.

FIGS. 1 and 2 are block diagram and flowchart illustrations of methods, apparatus(s) and computer program products according to an embodiment of the invention. It will be understood that each block of FIGS. 1 and 2, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

We claim:

1. A method of allowing a user to control the privacy level applied to an instant messaging session, comprising:
presenting a user interface for setting up said instant messaging session, wherein said user interface includes multiple selectable privacy settings, wherein each of said multiple selectable privacy settings indicates a limit with respect to at least one potential operation on the contents of said instant messaging session;
determining which of said multiple selectable privacy settings have been selected by an initiating user; and
communicating said selected one of said multiple selectable privacy settings to at least one computer system associated with each participant in said instant messaging session.

2. The method of claim 1, further comprising:
presenting a contact list in said user interface for setting up said instant messaging session, wherein said contact list includes indications of which of said multiple selectable privacy settings are available with respect to instant messaging sessions with each user listed in said contact list.

3. The method of claim 1, further comprising:
providing a user interface during said instant messaging session that enables only a user that initiated said instant messaging session to select different privacy settings than were initially selected during said instant messaging session.

4. The method of claim 3, further comprising:
providing a user interface during said instant messaging session to each participant in said instant messaging session that indicates which of said multiple selectable privacy settings were previously selected by said user that initiated said instant messaging session.

5. The method of claim 1, wherein said multiple selectable privacy settings include a setting which, if selected, prevents the contents of said instant messaging session from being copied and pasted while said instant messaging session is in progress.

6. The method of claim 1, wherein said multiple selectable privacy settings include a setting which, if selected, prevents any saving of the contents of said instant messaging session by any user.

7. The method of claim 1, wherein said multiple selectable privacy settings include a setting which, if selected, prevents the contents of said instant messaging session from being forwarded via electronic mail.

8. The method of claim 1, wherein said multiple selectable privacy settings include a setting which, if selected, prevents previously viewed contents of said instant messaging session from being viewed while said instant messaging session is in progress.

9. The method of claim 1, wherein said multiple selectable privacy settings include a setting which, if selected, prevents screen shots from being made of said contents of said instant messaging session while said instant messaging session is in progress.

10. A system including a computer readable medium, said computer readable medium having stored thereon program code for allowing a user to control the privacy level applied to an instant messaging session, said program code comprising:
program code for presenting a user interface for setting up said instant messaging session, wherein said user interface includes multiple selectable privacy settings, wherein each of said multiple selectable privacy settings indicates a limit with respect to at least one potential operation on the contents of said instant messaging session;
program code for determining which of said multiple selectable privacy settings have been selected by an initiating user; and
program code for communicating said selected one of said multiple selectable privacy settings to at least one computer system associated with each participant in said instant messaging session.

11. The system of claim 10, said program code further comprising:
program code for presenting a contact list in said user interface for setting up said instant messaging session, wherein said contact list includes indications of which of said multiple selectable privacy settings are available with respect to instant messaging sessions with each user listed in said contact list.

12. The system of claim 10, said program code further comprising:
program code for providing a user interface during said instant messaging session that enables only a user that initiated said instant messaging session to select different privacy settings than were initially selected during said instant messaging session.

13. The system of claim 12, said program code further comprising:
program code for providing a user interface during said instant messaging session to each participant in said instant messaging session that indicates which of said multiple selectable privacy settings were previously selected by said user that initiated said instant messaging session.

14. The system of claim 10, wherein said multiple selectable privacy settings include a setting which, if selected, prevents the contents of said instant messaging session from being copied and pasted while said instant messaging session is in progress.

15. The system of claim 10, wherein said multiple selectable privacy settings include a setting which, if selected, prevents any saving of the contents of said instant messaging session by any user.

16. The system of claim 10, wherein said multiple selectable privacy settings include a setting which, if selected, prevents the contents of said instant messaging session from being forwarded via electronic mail.

17. The system of claim 10, wherein said multiple selectable privacy settings include a setting which, if selected, prevents previously viewed contents of said instant messaging session from being viewed while said instant messaging session is in progress.

18. The system of claim 10, wherein said multiple selectable privacy settings include a setting which, if selected, prevents screen shots from being made of said contents of said instant messaging session while said instant messaging session is in progress.

19. A computer program product including a computer readable medium, said computer readable medium having stored thereon program code for allowing a user to control the privacy level applied to an instant messaging session, said program code comprising:
program code for presenting a user interface for setting up said instant messaging session, wherein said user interface includes multiple selectable privacy settings, wherein each of said multiple selectable privacy settings indicates a limit with respect to at least one potential operation on the contents of said instant messaging session;
program code for determining which of said multiple selectable privacy settings have been selected by an initiating user; and
program code for communicating said selected one of said multiple selectable privacy settings to at least one computer system associated with each participant in said instant messaging session.

20. A computer data signal embodied in a carrier wave, said computer data signal having program code stored thereon for allowing a user to control the privacy level applied to an instant messaging session, said program code comprising:
program code for presenting a user interface for setting up said instant messaging session, wherein said user interface includes multiple selectable privacy settings, wherein each of said multiple selectable privacy settings indicates a limit with respect to at least one potential operation on the contents of said instant messaging session;
program code for determining which of said multiple selectable privacy settings have been selected by an initiating user; and
program code for communicating said selected one of said multiple selectable privacy settings to at least one computer system associated with each participant in said instant messaging session.

21. A system for allowing a user to control the privacy level applied to an instant messaging session, comprising:
means for presenting a user interface for setting up said instant messaging session, wherein said user interface includes multiple selectable privacy settings, wherein each of said multiple selectable privacy settings indicates a limit with respect to at least one potential operation on the contents of said instant messaging session;
means for determining which of said multiple selectable privacy settings have been selected by an initiating user; and
means for communicating said selected one of said multiple selectable privacy settings to at least one computer system associated with each participant in said instant messaging session.
